(19) United States
(12) Patent Application Publication
(10) Pub. No.: US 2014/0352675 A1
(43) Pub. Date: Dec. 4, 2014

(54) Pressurization Device

(71) Applicant: Perkins Engines Company Limited, Cambridgeshire (GB)

(72) Inventor: Paul J. Smith, Cambridgeshire (GB)

(21) Appl. No.: 14/366,823

(22) PCT Filed: Dec. 17, 2012
(86) PCT No.: PCT/GB2012/000910

§ 371 Date: Jun. 19, 2014

(30) Foreign Application Priority Data
Dec. 19, 2011 (GB) 1121845.0

(51) Int. Cl. F02M 25/06; B67D 7/02; B67D 7/72; B67D 7/04

(52) U.S. Cl. CPC F02M 25/06; B67D 7/0478; B67D 7/0294; B67D 7/72
USPC 123/574; 222/95; 222/105; 222/394

(57) ABSTRACT

The present disclosure relates to an apparatus (10) for pressurizing a first substance, such as a liquid, gas or particulate material, to a pressure substantially equal or similar to the pressure of a second substance, i.e. a reference substance. The pressure of the reference substance may be transient so the pressure of the first substance must be varied accordingly. The present disclosure includes a bladder (71) disposed within a sealed can (40), an inlet passage (24a) in communication with the interior (41) of the can and an outlet passage (26a) in communication with the interior of bladder (71). The reference substance may be directed into the interior (41) of the can (40) via the inlet passage (24a) and pressurizes the bladder (71) and thus the first substance stored therein, thereby causing the first substance to be expelled via the outlet passage (26a) with a pressure substantially corresponding to that of the reference substance. Many applications exist that require two substances to be of a similar pressure. For example, an engine may be adapted to run on low lubricity fuel provided a pressurized lubricant is introduced to the pressurized fuel before being directed towards the injector.

### TECHNICAL FIELD

The present disclosure relates to a device for pressurizing a substance and more particularly to a device for pressurizing a substance to a pressure substantially equal or similar to that of another substance. The present disclosure also relates to component parts for such a device.

### BACKGROUND

Some installations use or consume various substances, including gases, liquids or particulates. Furthermore, those installations may require some of those substances to be at a particular pressure, and sometimes at a pressure substantially equal or similar to that of another substance. This requirement may be for various reasons, including the possibility of subsequently combining controlled quantities of first and second substances to create a composition of specific proportions of each substance. The effective control of those quantities may be improved when the first and second substances are at substantially the same pressure. The first and second substances may comprise particulates, liquids or gases and the composition may comprise a combination of any of those, e.g. a mixture of particulates and liquids.

Furthermore, the pressure of the first substance may be transient and therefore it may be necessary to be able to vary the pressure of the second substance accordingly. That is to say, it may not be appropriate merely to compress the second substance to a set pressure because the first substance may not be at a constant pressure. The pressure of the second substance must be adjusted rapidly in response to a sudden change in the pressure of the first substance.

Some installations requiring two substances of equal or similar pressures may be large, fixed installations where space and energy are of little concern. However, some smaller, mobile installations exist where available space and energy for pressurizing the second substance are rather limited and thus a significant concern.

For example, the engine of a vehicle uses or consumes various substances, such as fuels, coolants, refrigerants, lubricants, emissions fluids, hydraulic fluids and many other substances that may be pressurized or even combined with other substances. For instance, those engines may be adapted to run on alternative fuels that may need to be mixed with a lubricant prior to consumption to prevent excessive friction between moving parts, such as fuel pumps.

Systems are known for combining two or more substances, such as fuel and lubricant. However, those systems store the fuel-lubricant mixture in the tank ready for consumption and the substances are known to separate when left for some time or as they are drawn from the tank. This leads to fuel-lubricant mixtures having inconsistent quantities of fuel and lubricant.

Although the present disclosure is particularly relevant to industrial installations such as engines and heavy machinery, it is believed to be equally as applicable to any other apparatus requiring two or more substances to be of substantially equal or similar pressures.

It is an object of the present disclosure to address the problems associated with known pressurization systems so as to provide a pressurization system and a pressurization method with more versatility.

### SUMMARY OF THE DISCLOSURE

According to a first aspect of the disclosure, there is provided an additive container for connection to a pressurization device having a fluid inlet passage for receiving pressurized fluid and an additive outlet passage for dispensing pressurized additive, the additive container comprising: a flexible bladder for holding additive and having a bladder outlet through which additive may be expelled; and a support member provided on the flexible bladder and defining pressurization device connection means adapted to support the additive container relative to the pressurization device and to arrange the bladder outlet in fluid communication with the additive outlet passage.

According to a further aspect of the present disclosure, there is provided a pressurization device comprising: a first housing part defining a fluid inlet passage and an additive outlet passage; a second housing part detachably mounted to the first housing part, which together define a chamber in fluid communication with the fluid inlet passage; an additive container disposed within the chamber and defining an additive flow passage arranged in fluid communication with the additive outlet passage.

### BRIEF DESCRIPTION OF THE DRAWINGS

One embodiment of the present disclosure will now be described in detail, with reference being made to-the accompanying drawings, in which:

FIG. 1 is a front perspective view of pressurization device according to the disclosure;

FIG. 2 is an exploded view of the pressurization device of FIG. 1;

FIG. 3 is a front perspective view corresponding to FIG. 1, but with the can of the device removed for clarity.

FIG. 4 is a top perspective view of a head unit forming part of the pressurization device of FIGS. 1 to 3;

FIG. 5 is a bottom perspective view of the head unit of FIG. 4;

FIG. 6 is a cross-sectional view along the lines A-A shown in FIG. 4;

FIG. 7 is a cross-sectional view along the line B-B shown in FIG. 4;

FIG. 8 is a perspective view of the additive container forming part of the pressurization device of FIGS. 1 to 3;

FIG. 9 is an alternative perspective view of the additive container with the bladder removed for clarity, thus presenting a support member;

FIG. 10 is a cross-sectional view through the centre of the additive container shown in FIG. 8;

FIG. 11 shows a second alternative support member for the additive container;

FIG. 12 shows the second alternative support member in a different configuration;

FIG. 13 shows a third alternative support member for the additive container;

FIG. 14 shows the third alternative support member in a different configuration; and

FIG. 15 shows a cross-section through the centre of the device of FIG. 1, the device being fitted with an additive container furnished with the third alternative support member.

### DETAILED DESCRIPTION

The following is a detailed description of an exemplary embodiment of the present disclosure. The exemplary embodiment described therein and illustrated in the drawings is intended to teach the principles of the present disclosure, enabling those of ordinary skill in the art to implement and use the present disclosure in many different environments and for many different applications. Therefore, the exemplary embodiment is not intended to be, and should not be considered as, a limiting description of the scope of patent protection. Rather, the scope of patent protection shall be defined by the appended claims.

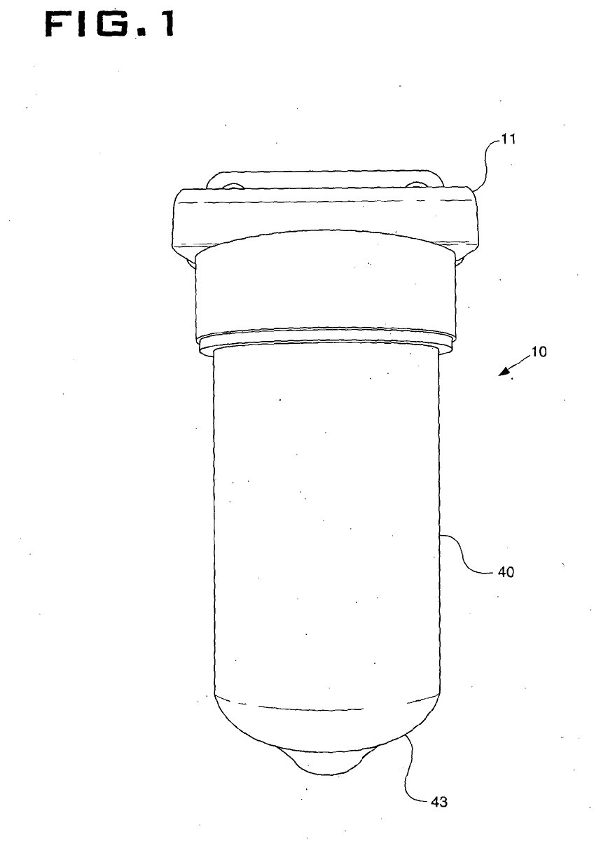

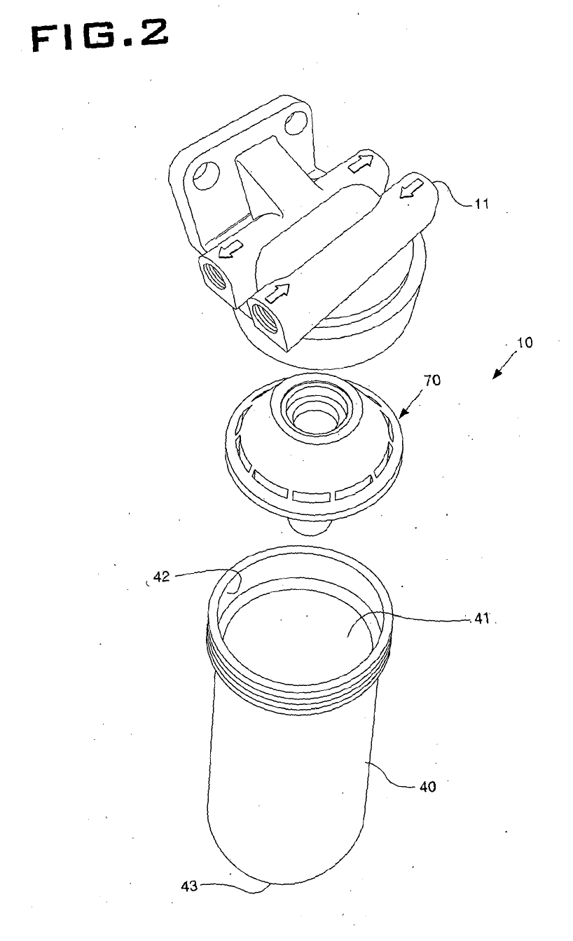

Referring to FIGS. 1 to 3, there is shown a device, generally indicated 10, for pressurizing a substance (not shown). The device 10 may be used for pressurizing a first substance contained in the device 10 to a pressure corresponding substantially to that of another substance. The device 10 is configured to pressurize a liquid substance, though it may also be suited to gaseous substances or particulate substances. In particular, the device 10 may be arranged for use with an additive such as a lubricant to be introduced to a fluid such as a liquid fuel, and thus serves to pressurize the additive to a pressure corresponding to that of the fluid. Controlled amounts of additive may be more easily introduced to the fluid when the additive and fluid are at the same pressure.

The device 10 may comprise a first housing part 11 to which the fluid may be delivered and from which the additives may be expelled at substantially the same pressure as the fluid. A second housing part 40 may be connected to the first housing part 11, which together define an interior space 41. An additive container 70 may be disposed within that interior space 41 and secured to the first housing part 11, the second housing part 40 or both to maintain its position. Each of which will be described in more detail below.

The first housing part 11 may fulfill several functions, such as providing a means of closing the interior of the second housing part 40, a means of directing additives (not shown) away from the device 10 and also a means of directing fluid towards the device. It may also provide a means of mounting the device 10 to a larger assembly, such, as an engine.

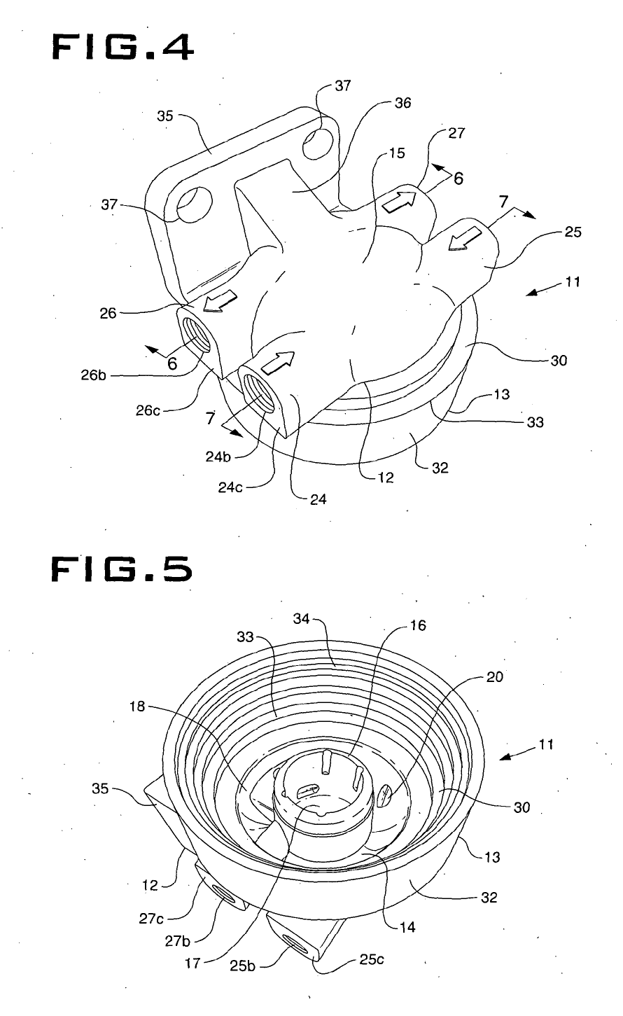

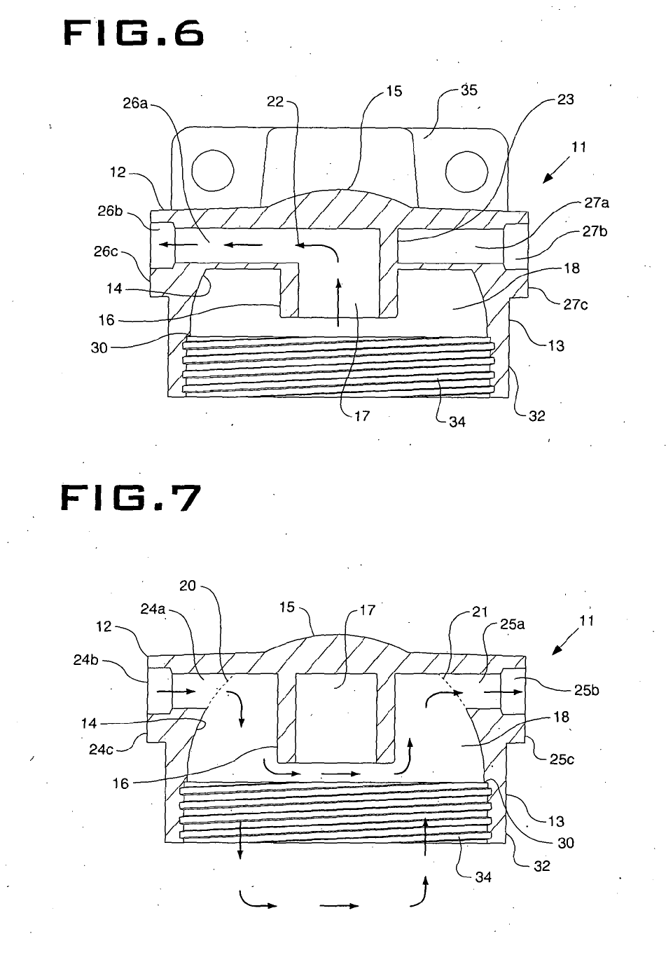

Referring now also to FIGS. 4 to 7, the first housing part 11 is generally cup-shaped insofar as it may define part of the interior space 41. Furthermore, the first housing part 11 may include an upper portion 12 that may be domed and a lower portion 13 that may be substantially cylindrical.

The upper portion 12 may define a substantially concave inner surface 14 and a convex outer surface 15. The interior space 41 includes an annular wall 16 depending substantially from the centre of the concave inner surface 14 so as to define an inner chamber 17 and an outer chamber 18. In this example the annular wall 16 is generally circular such that the inner chamber 17 is generally cylindrical and the outer chamber 18 is generally toroidal, though the annular wall 16 may be polygonal or any other shape.

The upper portion 12 may include fluid ports 20,21 for the delivery and expulsion of fluid and additive ports 22,23 for the expulsion of additives from the device 10. For example, the fluid ports 20,21 for the supply and expulsion of fluid may be located so as to communicate with the outer chamber 18 and the additive port 22 for the expulsion of additives may be located so as to communicate with the inner chamber 17. There may be any number of ports arranged in various positions on the upper portion 12 so as to provide a choice of configurations according to the space available within the installation.

Furthermore, the convex outer surface 15 may be furnished with fluid port members 24,25 and additive port members 26,27. Each fluid port member 24,25 and additive port member 26,27 may define a passage 24A,25A,26A,27A having an inner end defined by a respective fluid port 20,21 or additive port 22,23 and an outer end defined by an opening 24B,25B,26B,27B formed in an end face 24C,25C,26C,27C. Specifically, the fluid port members 24 and 25 may be arranged such that their fluid passages 24A,25A intersect the outer chamber 18 and the additive port members 26,27 are arranged such that their passages 26A,27A intersect the inner chamber 17. Further, fluid port members 24,25 and additive port members 26,27 may be arranged to extend outwardly from the periphery of the upper portion 12 and the end faces 24C,25C,26C,27C may be suitably arranged to receive a connector (not shown) provided on the end of a hose, pipe or suitable conduit (not shown). For instance, the end faces 24C,25C,26C,27C may be substantially flat and may be orientated in parallel planes. In the exemplified embodiment, the openings 24B,25B,26B,27B in each end face may be threaded so as to receive a threaded end portion of the connector provided on the end of a hose, pipe or suitable conduit. Each connector may have a flange adjacent the threaded portion that may bear against the end face 24C,25C,26C,27C of the fluid port members 24,25 and additive port members 26,27 when fully tightened. The flange may be hexagonal or otherwise suitably profiled to enable the connector to be fully tightened by hand or an appropriate tool.

One additive port 23 is plugged in the present example since it is not required for this particular installation. Were that additive port 23 to be required, it may be unplugged simply by drilling through the passage 27A such that the passage communicates with the inner chamber 17. In the present embodiment the fluid port members 24,25 and the additive port members 26,27 are arranged generally parallel to one another. Furthermore, the fluid port members 24,25 may be arranged such that their fluid passages 24A,25A are joined, and are possibly coaxial to aid flow. One of the openings 24B,25B may be arranged as an inlet and the other as an outlet. In this way, when the fluid passages 24A,25A are joined, some fluid may flow directly between the inlet and the outlet, while some fluid may flow in and out of the interior space 41, via the ports 20,21.

An annular lip 30 may be defined within the first housing part 11 and which may delineate the upper and lower portions 12,13. In the present embodiment, the annular lip 30 extends outwardly from a circumferential edge of the upper portion 12 and provides an interior surface against which the additive container 70 may bear when the device 10 is properly assembled. The lower portion 13 may comprise a skirt 32 depending downwardly from the outer circumferential edge 33 of the annular lip 30 so as to enclose a portion of the interior space 41. In this instance, the upper and lower portions 12,13 are both the same shape, though this need not necessarily be so. For instance, they may take different shapes depending on the size and shape of the installation or the size and shape of the additive container 40. The skirt 32 may be furnished with a threaded portion 34, possibly on its internal surface for engagement with a threaded portion 45 provided on the second housing part 40.

The first housing part 11 may be provided with a mounting bracket 35 by which the device 10 may be mounted to the installation (not shown), for example, an engine. The mounting bracket 35 may extend upwardly from an exterior surface of the annular lip 30 and may be arranged in a plane substantially normal to the plane of the annular lip 30, though other orientations may be preferable, again depending on the installation. Furthermore, a web 36 may extend between the mounting bracket and the upper portion 12 to provide increased rigidity. The mounting bracket 35 may be provided with one or more holes 37 for receiving bolts (not shown) or other suitable fasteners for securing the device 10 to the installation.

Referring again to FIGS. 1 to 3, the second housing part 40 may be a receptacle provided with an opening 42 adapted to connect to the first housing part 11 and sized to accommodate part of the additive container 70. The opening 42 may be adapted to engage sealingly with the first housing part 11 so as to avoid the egress of fluid flowing between those parts. In the present embodiment, the second housing part 40 is generally cylindrical with a rim 43 defining the opening 42 and the other end 44 being closed, though the second housing part 40 may take many shapes according to the available space within the installation. The second housing part 40 may include a threaded portion 45 for engagement with the threaded portion 34 of the skirt 32 of the first housing part 11. Since the threaded portion 34 is provided on the interior of the skirt 32, the threaded portion 45 in the present example is provided on the exterior of the second housing part 40. The depth of the threaded portion 45 of the second housing part 40 may be selected so that the rim 43 of the second housing part 40 may locate against or near the interior surface of the annular lip 30. Furthermore, the second housing part 40 may be furnished with an outwardly extending annular flange (not shown) disposed adjacent the threaded portion 45 and distal from the rim 43 so as to define a surface against which the free edge of the skirt 32 may bear when the second housing part 40 is connected to the first housing part 11. In addition, the second housing part 40 may be provided with a seal (not shown), such as an O-ring or the like, that may be lodged between the annular flange and the skirt 32 to restrict the egress of fluid therebetween.

In an alternative embodiment (not shown), the opening of the second housing part 40 and the skirt 32 of the first housing part 11 may be arranged to form a snug fit and may be secured by bolts or other suitable fasteners.

The can may be made of plastics or other material impermeable to the fluid for which the additive device may be used.

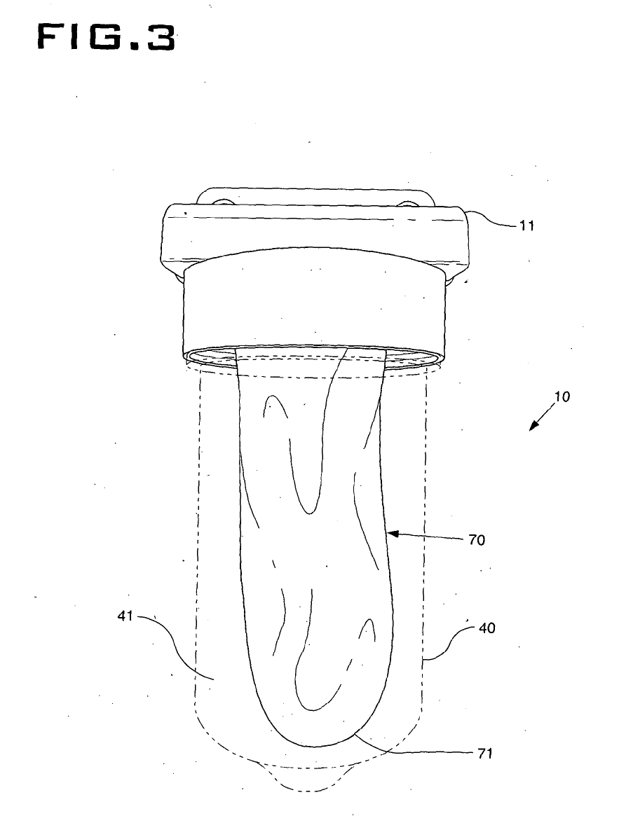

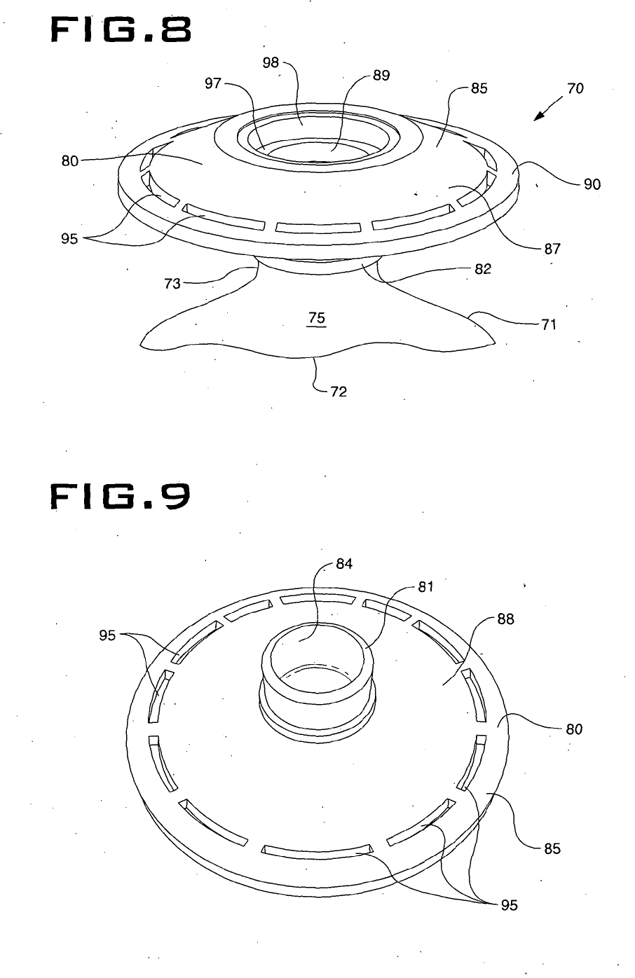

With reference to FIGS. 3 and 8 to 10, the additive container 70 may comprise a bladder 71 and a support member 80. The bladder 71 may comprise a main body 72 having a neck 73 defining an opening 74 into the interior 75 of the main body 72. The bladder 71 may be made from a material which is impermeable to the fluid and the additives with which the device 10 is to be used and which may enable the bladder 71 to deform elastically when subject to external pressure.

The support member 80 may be connected to the bladder 71 and may locate securely within the first housing part 11. The support member 80 may include a collar 81 over which the neck 73 of the bladder 71 locates and which may take any shape, though in the present example it is substantially circular. The neck 73 of the bladder 71 may be clamped onto the collar 81 by a ferule 82 or other mechanism that may create a hermetic seal between the collar 81 and the bladder 71. The collar 81 may include a flow passage 84, which may take any shape, but in the present embodiment is cylindrical since it is defined by the inner circumferential face of the collar. The support member 80 may further include support means 85 which may extend outwardly from the collar 81 for supporting the additive container 70 on the second housing part 40 or the first housing part 11. In one embodiment (not shown), the support means 85 may include a plurality of struts extending from the collar 81, possibly in a radial direction, and having free ends that locate against the interior surface of the annular lip 30.

In the present embodiment the support means 85 include a disc having opposed upper and lower faces 87,88 and an aperture 89 extending between those upper and lower faces 87,88. The collar 81 may depend downwardly from the lower face 88 and the aperture 89 may be sized and positioned such that its axis is coaxial with that of the collar 81. This way, the collar 81 and the aperture 89 may together define the flow passage 84 for additives being expelled from the bladder 71.

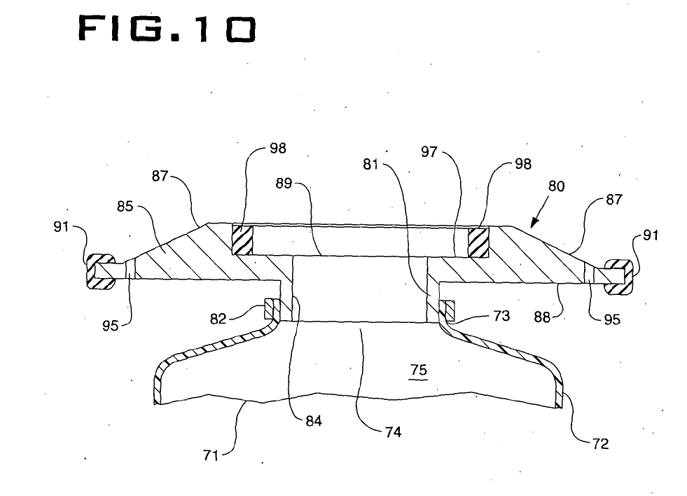

The outer periphery 90 of the disc 85 may have a substantially uniform thickness and may locate on the interior surface of the annular lip 30 so as to be trapped in position by the rim 43 of the second housing part 40 once it is screwed onto the skirt 32. In the present example, the outer periphery 90 of the disc 85 carries an annular seal 91 (FIG. 10) to restrict the leakage of fluid between the second housing part 40 and the first housing part 11. The annular seal 91 may be of a flexible nature such that as it is compressed between the annular lip 30 and the rim 43 of the second housing part 40 it may extend laterally towards the skirt 32 to prevent the egress of fluid from the device 10.

Orifices 95 may be defined within the disc 85, possibly at a location proximal to the outer periphery 90 of the disc or adjacent the annular seal 91 if present, thereby enabling fluid in the outer chamber 18 to pass beyond the support member 80 and into the interior space 41 of the second housing part 40. To facilitate this, the upper face 87 of the disc may be frusto-conical so as to cause fluid falling thereon to drain towards the orifices 95.

A portion of the aperture 89 adjacent the upper face 87 of the disc 85 may be diametrically larger than the remainder of the flow passage 84 so as to define an annular recess 97. The annular recess 97 may be furnished with an annular seal 98, which may be adhered or otherwise secured within the annular recess. The annular seal 98 may have an internal diameter which is larger than the internal diameter of the flow passage 84 such that part of the annular recess 97 remains visible when the annular seal 98 is in place. Thus, when the device 10 is fully assembled, the free end of the annular wall 16 depending from the concave inner surface 14 of the first housing part 11 may locate in and form a snug fit with the annular seal 98. The inner diameter of the annular wall 16 may be at least as large as the diameter of the flow passage 84 so as not to restrict flow.

To prevent additives leaking from the additive container 70 prior to assembly, the flow passage 84 may be temporarily closed by a removable cap or bung (not shown). For instance the cap may sit within the annular recess 97 and may be removed and disposed of immediately before fitting the additive container 70 to the device 10.

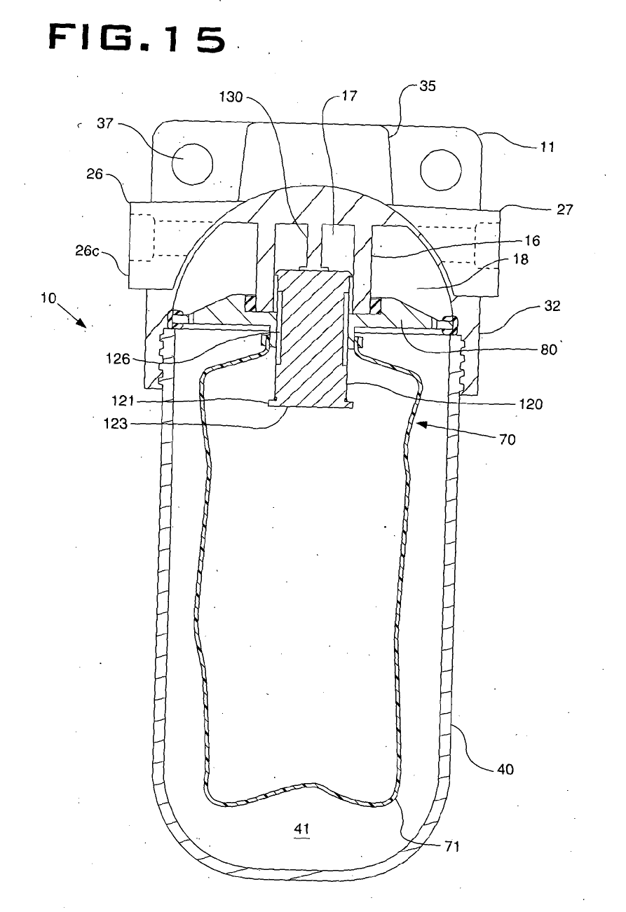

Two alternative types of support members 80′,80″ are shown in FIGS. 11 to 15, which include a closing mechanism that opens automatically during installation. Each of these will be discuss separately below.

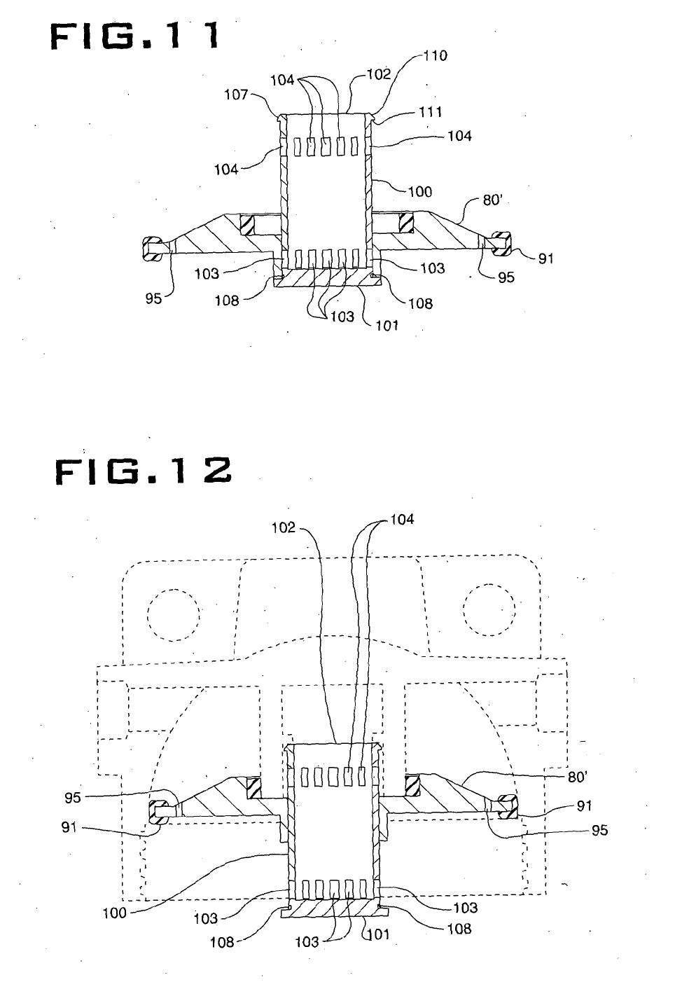

Referring to FIGS. 11 and 12, the support member 80′ is provided with a closing member 100, which is disposed within the flow passage 84 and arranged for sliding movement therealong between closed (FIG. 11) and open (FIG. 12) positions. The closing member 100 may be generally cylindrical and may be sized to form a snug fit within the flow passage 84. Thus, the cross-section of the closing member 100 may correspond to the shape of the flow passage 84. The closing member 100 may be tubular and may have one closed end 101 and one open end 102, the closed end in this particular embodiment being the end proximal to the bladder 71. The closing member 100 may also include one or more inlets 103 formed adjacent the one closed end 101 and optionally one or more outlets 104 formed towards the one open end 102 so as to facilitate flow of additives from the bladder 71 to the inner chamber 17, when the closing member 100 is in its open position, as shown in FIG. 12.

Furthermore, the closing member 100 may be provided with abutments 106,107 at the closed and open ends 101,102, respectively. The abutment 106 at the closed end may extend at least part way around the closing member 100 so at to engage the free end of the collar 81 when in its closed position. This serves to limit axial displacement of the closing member 100 in a direction away from the bladder 71 and also to serve as a seal. The sealing characteristics may be further improved by the provision of an O-ring 108, or equivalent seal, adjacent the abutment 106 at the closed end for engaging the annular wall 16.

The abutment 107 at the open end may serve to limit axial displacement of the closing member 100 into the bladder 71 while permitting insertion of the closing member into the flow passage 84. The abutment 107 at the open end may be angled relative to the collar 81 so as to define a sloping surface 110 and an abutment surface 111. The sloping surface 110 may cause the closing member 100 to deflect or deform slightly as it is urged into the flow passage 84 during assembly and the abutment surface 111 may engage the annular recess 97 should attempts be made to remove the closing member 100 from the flow passage 84.

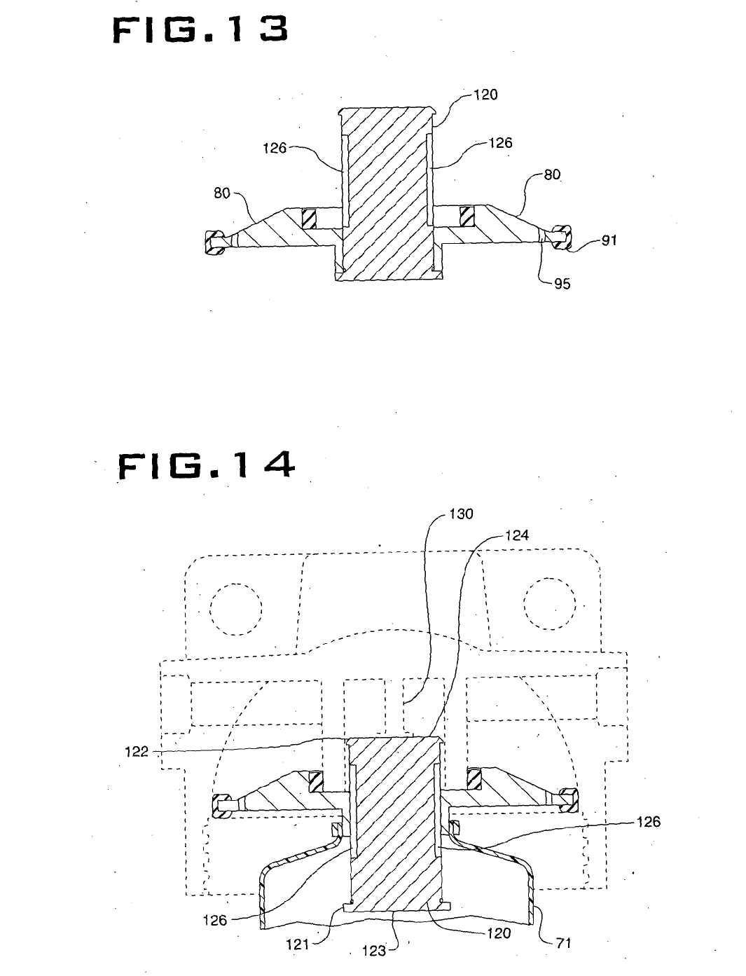

The support member 80″ shown in FIGS. 13 to 15 may include a closing member 120 which may also be adapted to slide along the flow passage 84. In the present example, the closing member 120 is generally cylindrical and has abutments 121,122 at opposed ends 123,124 much like those of the first arrangement described above. However, this second closing member 120 need not be tubular, but may include elongate recesses 126 extending partway along its length so as to define a flow path for the fluid. The elongate recesses 126 may be longer than the length of the flow passage 84, but extend between the interior 73 of the bladder 71 and the inner chamber 17 of the head unit only when the second closing member 120 is in its open position (FIG. 14). In the closed position, the ends of the elongate recesses 126 are within the flow passage 84 so cannot be accessed from the interior 73 of the bladder 71, thus restricting the flow of additive towards the inner chamber 17.

### INDUSTRIAL APPLICABILITY

To fit the device 10, first of all the first housing part 11 may be attached to the installation. This may be achieved by presenting the mounting bracket 35 to an appropriate surface on the installation such that the holes 37 align with corresponding holes formed in the appropriate surface. The first housing part 11 may be secured in place by bolts extending through the holes 37 and the corresponding holes in the appropriate surface.

The second housing part 40 and the additive container 70 may then be connected to the first housing part 11. The easiest way to do this may be first to position the additive container 70 on the second housing part 40 such that the bladder 71 locates within the interior space 41 and the outer periphery 90 rests on the rim 43 of the second housing part 40 defining the opening 42. The second housing part 40 and the additives container 70 may then be secured to the first housing part 11. This may be achieved by screwing the second housing part 40 onto the skirt 32 so as to engage the threaded portion 45 with the threaded portion 34. Once the second housing part 40 is fully screwed onto the first housing part 11, the outer periphery 90 of the support member 80 will be firmly clamped between the annular lip 30 of the first housing part 11 and the rim 43 of the second housing part 40. The clamping pressure may cause the annular seal 91 to deform so as to extend radially and thus seal the interface between the first housing part 11 and the second housing part 40. Furthermore, the annular wall 16 depending from the concave inner surface 14 may locate in the annular recess 97 and against the annular seal 98 so as to restrict or prevent additives leaking into the outer chamber 18.

The modified additive containers shown in FIGS. 11 to 15 include a second closing member 100,120 that is activated automatically as the second housing part 40 is screwed onto the first housing part 11. The closing member 100 shown in FIGS. 11 and 12 engages one or more abutments 110 extending radially inwardly from the annular wall 16, thereby preventing axial movement of the closing member 100 relative to the first housing part 11 as the second housing part 40 and the support member 80 advance further into the first housing part 11. The relative axial movement of the closing member 100 and the support member 80′ effectively leads to the closing member 100 lowering into the bladder 71 and opening the flow passage 84.

The closing member 120 shown in FIGS. 13 to 15 works in a very similar manner to the closing member 100 of FIGS. 11 and 12. The main difference is that the end of the second closing member 120 proximal to the first housing part 11 may engage a stud 130 depending from the concave inner surface 14. This stud 130 prevents axial movement of the second closing member 120 relative to the first housing part 11, as the second housing part 40 and the support member 80 advance towards the first housing part 11 during the screwing action.

It is then a case of plumbing the device by attaching the connectors (not shown) of the conduits to the corresponding openings 24B,25B,26B,27B of the fluid port members 24,25 and the additive port members 26,27 and also by plugging any superfluous openings. The connector provided on the end of the additive delivery hose may be threaded on to the opening 26B of the additive port member 26 such that the flange of the connector bears against the end face 26C. Depending on the configuration of the installation and thus the available space, it may be preferable to attach the additive delivery hose to the additive port member 27, which might require the passage 27A to be drilled and the passage 26A to be plugged. Similarly, the connector provided on the end of the fluid delivery hose may be threaded into the opening 25B of the fluid port member 25 and the connector provided on the end of the fluid supply hose may be threaded onto the opening 24B of the fluid port member 24. Since the fluid passages 24A,25A in the fluid port members 24,25 each lead to the outer chamber 18, they may be conversely configured depending on the hose routing of the particular installation. That is to say, the connector of the fluid delivery hose may be attached to the opening 24B of the fluid port member 24 and the connector of the fluid supply hose may be attached to the opening 25B of the other fluid port member 25.

In use, fluid may flow through the fluid supply hose, through the passage 24A of the fluid inlet port member 24 and into the outer chamber 18 whence it flows through the orifices 95 and into the interior space 41. Fluid may be drawn from the interior space 41, outer chamber 18 and passage 25A of the fluid port member 25 and delivered through the delivery hose to another components, such as a mixer. Fluid may also flow directly between the fluid passages 24A,25A.

The pressure of the fluid in the interior space 41 is substantially the same as the pressure of the fluid elsewhere in the system. The fluid in the interior space pressurizes the bladder 71, which in turn pressurizes the additives inside the bladder 71. Those additives are then expelled through the flow passage 84, through the passage 26A within the additive port member 26 and through the additive delivery hose whereat the pressure of the additives is substantially equal to the pressure of the fluid in the system. The additives may then flow towards another component, such as the mixer where they may be introduced to the fluid.

1. An additive container for connection to a pressurization device having a fluid inlet passage for receiving pressurized fluid and an additive outlet passage for dispensing pressurized additive, the additive container comprising:
a flexible bladder for holding additive and having a bladder outlet through which additive may be expelled; and
a support member provided on the flexible bladder and defining pressurization device connection means adapted to support the additive container relative to the pressurization device and to arrange the bladder outlet in fluid communication with the additive outlet passage.

2. An additive container as claimed in claim 1, wherein the flexible bladder has a neck defining the bladder outlet and the support member includes a collar to which the neck attaches to define an additive flow passage.

3. An additive container as claimed in claim 2, wherein the support member is furnished with an additive seal member adapted to form a seal between the collar and the additive outlet passage when the additive container is fitted to the pressurization device.

4. An additive container as claimed in claim 1, and further comprising a closing member operable to control the flow of additive expelled from the bladder.

5. An additive container as claimed in claim 17, wherein the closing member forms a snug fit within a portion of the collar and is arranged to slide axially between a closed position whereat it restricts the flow of the additive from the bladder and an open position whereat it permits the flow of additive from the bladder.

6. An additive container as claimed in claim 4, wherein the closing member defines a flow path which is arranged to facilitate fluid communication between the bladder and the additive outlet passage of the pressurization device only when said closing member is in its open position.

7. An additive container as claimed in claim 6, wherein the device attachment means comprise a peripheral portion of the support member configured to locate against opposed seats defined in the pressurization device.

8. An additive container as claimed in claim 1, wherein the support member includes an outer seal for engagement with the pressurization device.

9. An additive container as claimed in claim 1, wherein the support member at least partially defines a fluid flow path isolated from the additive flow path and configured to enable fluid to flow between opposed sides of the support member when disposed within the pressurization device.

10. A pressurization device comprising:
a first housing part defining a fluid inlet passage and an additive outlet passage;
a second housing part detachably mounted to the first housing part, which together define a chamber in fluid communication with the fluid inlet passage;
an additive container disposed within the chamber and defining an additive flow passage arranged in fluid communication with the additive outlet passage.

11. A pressurization device as claimed in claim 10, wherein the first housing part includes a fluid outlet passage arranged in fluid communication with the chamber.

12. A pressurization device as claimed in claim 10, wherein the additive container comprises the additive container further includes a flexible bladder for holding additive and having a bladder outlet through which additive may be expelled, and a support member provided on the flexible bladder and defining pressurization device connection means adapted to support the additive container relative to the pressurization device and to arrange the bladder outlet in fluid communication with the additive outlet passage.

13. A pressurization device as claimed in claim 12, wherein the flexible bladder has a neck defining the bladder outlet and the support member includes a collar to which the neck attaches to define an additive flow passage, the additive container further includes a closing member operable to control the flow of additive expelled from the bladder, the closing member forms a snug fit within a portion of the collar and is arranged to slide axially between a closed position whereat it restricts the flow of the additive from the bladder and an open position whereat it permits the flow of additive from the bladder, and the first housing part defines an abutment surface against which the closing member bears so as to urge the closing member in its open position during assembly.

14. A pressurization device as claimed in claim 10, wherein the first housing part defines a sealing portion arranged to engage the additive container and facilitate fluid communication between the bladder and the additive outlet passage.

15. A fuel system comprising:
a fuel supply;
at least one fuel injector;
a conduit extending between the fuel tank and the at least one fuel injector so as to define a fuel flow path between the fuel tank and the at least one injector;
a pump disposed within the conduit to draw fuel from the fuel supply; and
a pressurization device as claimed in claim 10, the fluid inlet passage of the pressurization device being in fluid communication with the conduit.

16. A fuel system as claimed in claim 15, and further comprising mixing means configured to connect the fluid outlet passage to the conduit at a location downstream of the pressurization device.

17. An additive container as claimed in claim 2, and further comprising a closing member operable to control the flow of additive expelled from the bladder.

18. An additive container as claimed in claim 3, and further comprising a closing member operable to control the flow of additive expelled from the bladder.

19. A pressurization device as claimed in claim 12, wherein the additive container further includes a closing member operable to control the flow of additive expelled from the bladder, the closing member defines a flow path which is arranged to facilitate fluid communication between the bladder and the additive outlet passage of the pressurization device only when said closing member is in its open position, and the first housing part defines an abutment surface against which the closing member bears so as to urge the closing member in its open position during assembly.

20. An additive container as claimed in claim 5, wherein the closing member defines a flow path which is arranged to facilitate fluid communication between the bladder and the additive outlet passage of the pressurization device only when said closing member is in its open position.
